(19) United States
(12) Patent Application Publication
(10) Pub. No.: US 2013/0182605 A1
(43) Pub. Date: Jul. 18, 2013

(54) METHOD AND SYSTEM FOR PROVIDING A MOBILE VIRTUAL ROUTER

(71) Applicants: Ning So, Plano, TX (US); Andrea Fumagalli, Dallas, TX (US); Yuhua Chen, Houston, TX (US)

(72) Inventors: Ning So, Plano, TX (US); Andrea Fumagalli, Dallas, TX (US); Yuhua Chen, Houston, TX (US)

(73) Assignee: Verizon Patent and Licensing Inc., Basking Ridge, NJ (US)

(21) Appl. No.: 13/349,731

(22) Filed: Jan. 13, 2012

(51) Int. Cl. H04W 84/18

(52) U.S. Cl. 370/254

(57) ABSTRACT

An approach is provided for creating mobile virtual routers (MVRs). A mobile virtual router is dynamically configured based on an application, wherein the mobile virtual router includes a control plane instance, a forwarding plane instance, and a management plane instance. Data associated with the application is forwarded over the network using the mobile virtual router. The control plane instance, the forwarding plane instance, and the management plane instance are moveable among the plurality of physical routers.

### BACKGROUND INFORMATION

With the increase in demand for broadband communications and services, telecommunication service providers are continually challenged to provide the fastest and most reliable service to their customers to accommodate a wide variety of applications and services. Not surprisingly, a vast interconnection of data networks has emerged to support these applications and services. However, traditionally, such networks are static, in terms of allocation of network resources. In other words, any fluctuation or variation in resource demand can undermine statically engineered network resources. A key factor in the variability of network resources is the fact that user devices (e.g., smartphones, laptops, tablet computers, etc.) are mobile in nature, and thereby imposes variable demand on the network depending on the mobility of the users. Such mobility can be unpredictable, and thus, static network architectures are ill-suited.

Therefore, there is a need for an approach to accommodate the mobile nature of sophisticated services and applications.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a mobile virtual network capable of dynamically adapting, according to one embodiment;

FIG. 2 is a diagram of a mobile virtual router utilized in the system of FIG. 1, according to one embodiment;

FIG. 3 is a diagram of a mobile virtual network supporting services of a network cloud, according to one embodiment;

FIG. 4 is a flowchart of a process for dynamically configuring a mobile virtual router, according to one embodiment;

FIG. 5 is a flowchart of a process for notifying a candidate physical router to execute a mobile virtual router, according to one embodiment;

FIG. 6 is a diagram of an exemplary system with mobile deployment, according to one embodiment;

FIG. 7 is a diagram of a computer system that can be used to implement various exemplary embodiments; and

FIG. 8 is a diagram of a chip set that can be used to implement various exemplary embodiments.

### DESCRIPTION OF THE PREFERRED EMBODIMENT

A preferred apparatus, method, and software for providing a mobile virtual router are described. In the following description, for the purposes of explanation, numerous specific details are set forth in order to provide a thorough understanding of the preferred embodiments of the invention. It is apparent, however, that the preferred embodiments may be practiced without these specific details or with an equivalent arrangement. In other instances, well-known structures and devices are shown in block diagram form in order to avoid unnecessarily obscuring of the preferred embodiments of the invention.

Although various exemplary embodiments are described with respect to networks that carry data packets using Multiprotocol Label Switching (MPLS) technology, it is contemplated that various exemplary embodiments are applicable to other equivalent systems and traffic flows.

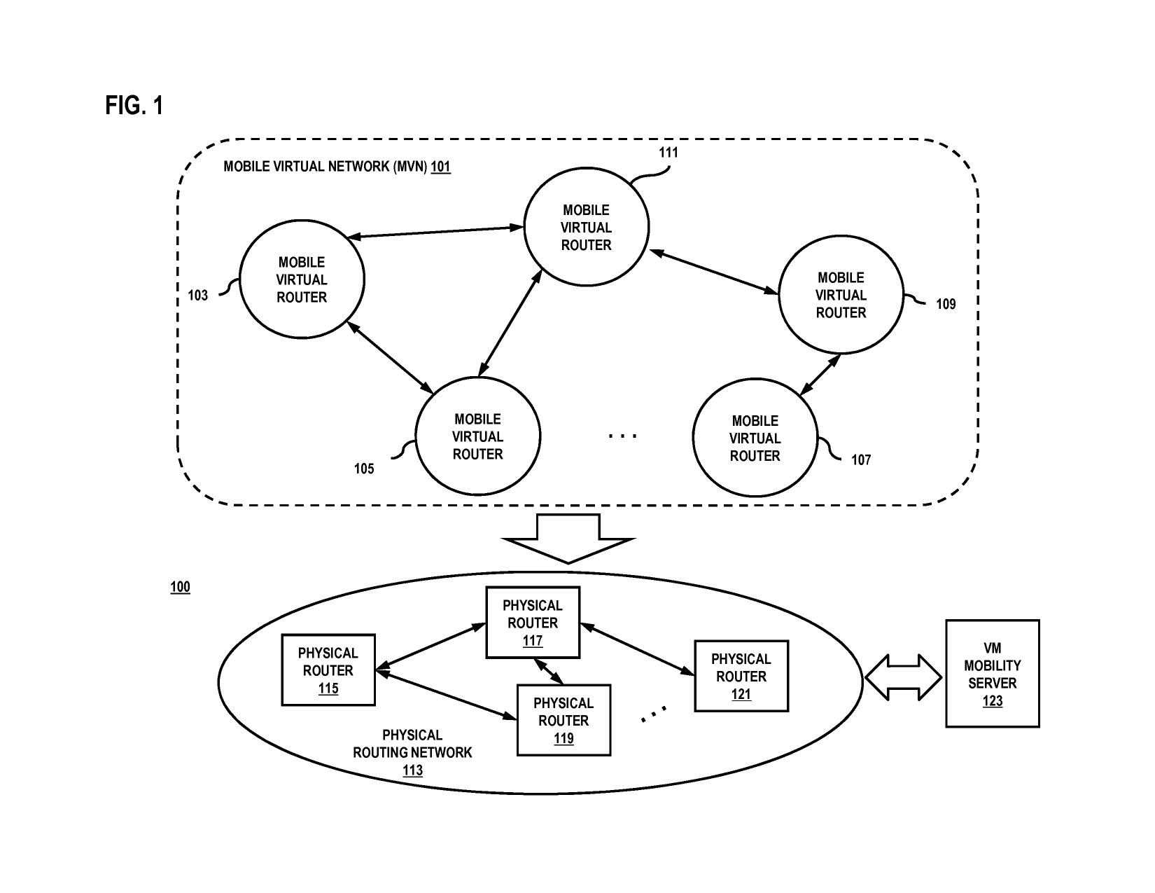

FIG. 1 is a diagram of a mobile virtual network capable of dynamically adapting, according to one embodiment. For the purpose of illustration, system 100 includes a mobile virtual network 101 that employs one or more mobile virtual routers (MVRs) 103-111. Under this scenario, mobile virtual network 101 can be effectively implemented or overlaid onto a physical routing network 113, which comprises one or more physical routers 115-121. As shown, a virtual machine (VM) mobility server 123 communicates with the physical routing network 113, among other functions, to create and tear down the mobile virtual network 101. Mobile virtual network 101 is thus a virtual network that can be created by the mobile virtual routers 103-111, and can move/migrate/adapt using mobile virtual routers 103-111 as the event participants/virtual servers move. MVRs 103-111 can be created and/or changed using underlining physical routers' available resources. Thus, MVRs 103-111 may grow or shrink during their lifetime.

In certain embodiments, MVRs 103-111 can be configured/auto-configured to move from one physical router (e.g., router 115) to another physical router (e.g., router 117) without service and traffic interruption. Traditionally, virtual routers can be hardware-based virtual router (HVR) or software-based virtual router (SVR). HVR typically refers to multiple virtual routers that share the same physical chassis and some common supporting resources, such as power supply, cooling, management port, switching fabric, and so on. However, critical control plane and forwarding plane resources (sometimes even management plane resources) are not shared. For example, the typical control plane resources that are not shared include central processing unit (CPU) (primary and back-up) and memory. The typical forwarding plane resources that are not shared include interface cards and backplane cards that support plug-in interface cards. SVR typically refers to multiple virtual routers that share all the physical resources available in the physical router. The only separation of the SVRs is the separation of virtual resources. For example, each SVR has separate control plane in the form of routing information database (routing tables); separate forwarding plane in the form of forward information databases (logical interface tables and, e.g., IGP/TE databases); and separate management plane (security and user control, system log, monitoring and reporting, and so on).

Under existing approaches, HVR and SVR technologies are not mobile—meaning that they are statically provisioned and activated on an existing physical router. Furthermore, HVR and SVR are typically a subset of a single physical router; that is, each physical router can have one or more HVRs and/or SVRs, but not the converse. Namely, the HVRs and/or SVRs cannot be associated with multiple routers.

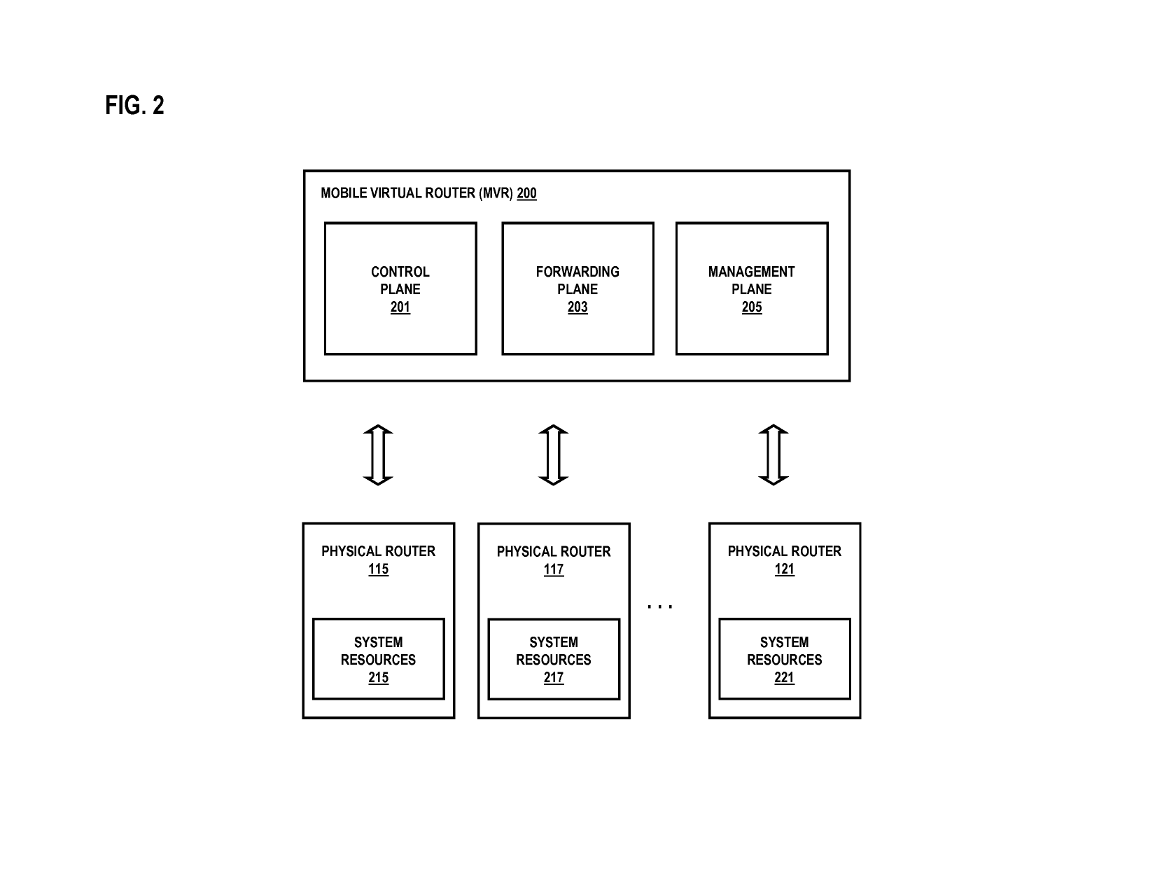

Each of the MVRs 103-111 is hybrid virtual router, and can be backward compatible with existing router technologies, e.g., HVR, SVR. Details of a mobile virtual router are more fully described with respect to FIG. 2. Unlike HVRs and SVRs, MVR (e.g., any one of routers 103-111) is highly dynamic, and flexible. MVRs 103-111 can, for instance, readily support and enable a variety of network operations that are required in cloud architectures as well as in the evolving global Internet.

The above arrangement, according to certain embodiments, can provide self-configuration, traffic congestion avoidance under multiple failures conditions, scaling of MVR to accommodate application types, as well as performance optimization. Regarding self-configuration of a newly created network (e.g., MVN 101), the MVR can be the foundation of an application driven network. In this manner, the network 101 can be built (along with the services being provisioned) by an application on demand. With respect to traffic congestion avoidance, MVR can be used to alter the logical topology of the network 101, creating local equal-cost multi-path (ECMP) conditions during the multiple failures conditions. Consequently, the resulting traffic congestions can be minimized. With the continuous broadening of application types and the widening range of their related performance (in terms of bandwidth and other network resources that are required to support them), MVRs can be custom created to best support these applications. Small MVRs can be created as needed, by reserving a small fraction of one physical router's resources. Large MVRs can be created where and as needed, by combining together reserved resources belonging to a number of physical routers. As a result, physical router resources are more effectively utilized, including the control plane resources such as CPU and memory. MVRs enable performance optimization in the growing mobile network environment: MVR allows the network 101 to become dynamic—i.e., a moving and changing entity over time. These network changes, among other things, can match the network structure composed of MVRs to the mobility pattern of both users and applications (e.g., virtual machines or VMs). Moreover, such changes can best support and optimize end-to-end communication performance between mobile users and applications.

As for the physical routing network 113, this network 113 can employ technologies such as Multiprotocol Label Switching (MPLS). For example, MPLS technology is based on setting up virtual paths between communication nodes (e.g., routers) in a network. MPLS provides high speed transfer of packets over data networks by appending labels to packets that contain information related to the path that the data packet will take to reach its destination. The use of such labels eliminates the need for routers to examine the header of each packet, resulting in the faster delivery of packets to their destination. The details on MPLS technology is further described in Internet Engineering Task Force (IETF) Request for Comment (RFC) 3031, which is incorporated herein in its entirety. Even though various technologies such as MPLS predominantly support fast delivery of packets, the characteristics and construction of the physical network infrastructure plays an equally vital role. Moreover, it is recognized that multi-protocol label switching (MPLS) traffic engineering (TE) has been developed to provide network administrators with the ability to control and manipulate the flow of traffic through a network. MPLS-TE utilizes label switching techniques to construct label switched paths (LSP), label distribution protocol (LDP) flows, and fast re-route (FRR) tunnels on one or more links interconnecting nodes of one or more networks (or autonomous systems). Routing protocols are utilized to determine MPLS traffic flow routes through the network 113, as well as govern the distribution of routing information between nodes 115-121.

By way of example, physical routers 115-121, as routing nodes, may include bridges, firewalls, gateways, laptop computers, mobile telephones, personal digital assistants, personal computers, routers, set top boxes, servers, switches, video game devices, workstations, or any other suitable device, customer premise equipment, etc., capable of routing functions, such as layer three routing (or data transfer) functions associated with the open systems interconnection (OSI) reference model. It is noted that physical routers 115-121 may route transmission units over network 113 based on one or more routing protocols, such as boarder gateway protocol (BGP), constrained shortest path first (CSPF), exterior gateway protocol (EGP), interior gateway routing protocol (IGRP), enhanced interior gateway routing protocol (EIGRP), intermediate system to intermediate system (IS-IS) protocol, routing information protocol (RIP), open shortest path first (OSPF), or any other suitable routing protocol.

Mobile virtual network 101 can provide a transport environment, in certain embodiments, for other networks (not shown). These networks may include one or more telephony networks, e.g., a circuit-switched network, such as the public switched telephone network (PSTN), an integrated services digital network (ISDN), a private branch exchange (PBX), or other like network. In other instances, such networks may also (or alternatively) include one or more wireless networks that employ one or more access technologies, such as, for example, code division multiple access (CDMA), enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE), wireless fidelity (WiFi), satellite, and the like. According to various embodiments, the networks may further include one or more data networks, such as one or more local area networks (LAN), metropolitan area networks (MAN), wide area networks (WAN), the Internet, or any other suitable packet-switched network, such as a commercially owned, proprietary packet-switched network having voice over internet protocol (VoIP) capabilities, e.g., a proprietary cable or fiber-optic network.

FIG. 2 is a diagram of a mobile virtual router utilized in the system of FIG. 1, according to one embodiment. Mobile virtual router 200, in certain embodiments, includes a control plane 201, a forwarding plane 203, and a management plane 205. Unlike HVR or SVR, MVR 200 is mobile; that is, control plane 201, forwarding plane 203, and management plane 205 instances can be removed from one physical router (e.g., router 115) and replicated on a different physical router (e.g., router 117 or router 121, etc.) over time. If needed, the services and traffic carried by one MVR can be dynamically moved to the mirrored/replicated MVR without service interruption. Moreover, each MVR 200 may make use of a superset of a number of physical routers 115-121. Consequently, multiple and decentralized instances of the control plane 201, forwarding plane 203, and management plane 205 of one single MVR 200 may coexist in more than one physical router, and may utilize the physical resources (e.g., system resources 215, 217 and 221) of all those physical routers 115-121 simultaneously. An example of this function is one MVR that makes use of all the physical routers 115-121 in the network (e.g., network 101).

The decentralized control instances may be viewed as a single control entity to make the internal MVR structure completely transparent to other MVRs and conventional router architectures. Furthermore, these functions can be combined to jointly work in the same MVR at once. For example, the MVR control instances may first be provisioned and activated in one physical router 115. If needed, these instances can be extended to work in a decentralized way across router 115 and a second physical router 117. By way of example, at a later time, the MVR control plane instances may be restricted to run on router 117 only, thus freeing the resources 215 of physical router 115 to be used by other MVRs.

Exchange of information for coordination and data transmission between decentralized instances of the same MVR may take place using both standard and/or proprietary interfaces and protocols that are best suited for these tasks. In other words, a number of protocols can be specified and embedded into the network architecture to have the MVR dynamically set up and torn down based on the VM mobility and current location. The protocol can announce the capability of the MVR running on a given physical router to other physical routers that may host the MVR next. This protocol can include the signaling and communication exchange between routers 115-121 in the same network 113 (autonomous system), between routers in different networks, between routers 115-121 and the VM mobility server 123, an Application Control Gateway (ACG) (not shown) and a Network Control Gateway (NCG) (not shown).

Additionally, the protocol can permit the VM mobility server 123 to signal the VM mobility occurrence. This protocol can contain the detailed information regarding the VM relocation, such as VM's network address (e.g., Internet Protocol (IP)) and Medium Access Control (MAC) addresses, VM's “before and after” location, VM user locations, VM move duration, any routing performance requirements (bandwidth, latency, affinity, etc.), any security requirements, and etc. Moreover, the protocol can also be used by ACG, NCG, and MVRs to determine if and how MVRs are to be moved/set up in order to optimize the network routing based on the VM new location.

In certain embodiments, a modified IGP protocol is used by the MVR (e.g., MVR 103) to announce its existence/formation as well as by an existing MVR to announce its termination to all routers within the network. This protocol can trigger the network optimization process in response to the resulting change of network topology.

Furthermore, the protocol can be utilized by the VM mobility server 123 to signal the end of session of the relocated VM to a number of network/cloud modules. These modules, in some embodiments, include ACG, NCG, and MVRs, and can determine if existing MVRs need to be torn down or not. This protocol can also contain the detailed information regarding the VM that is being terminated or relocated.

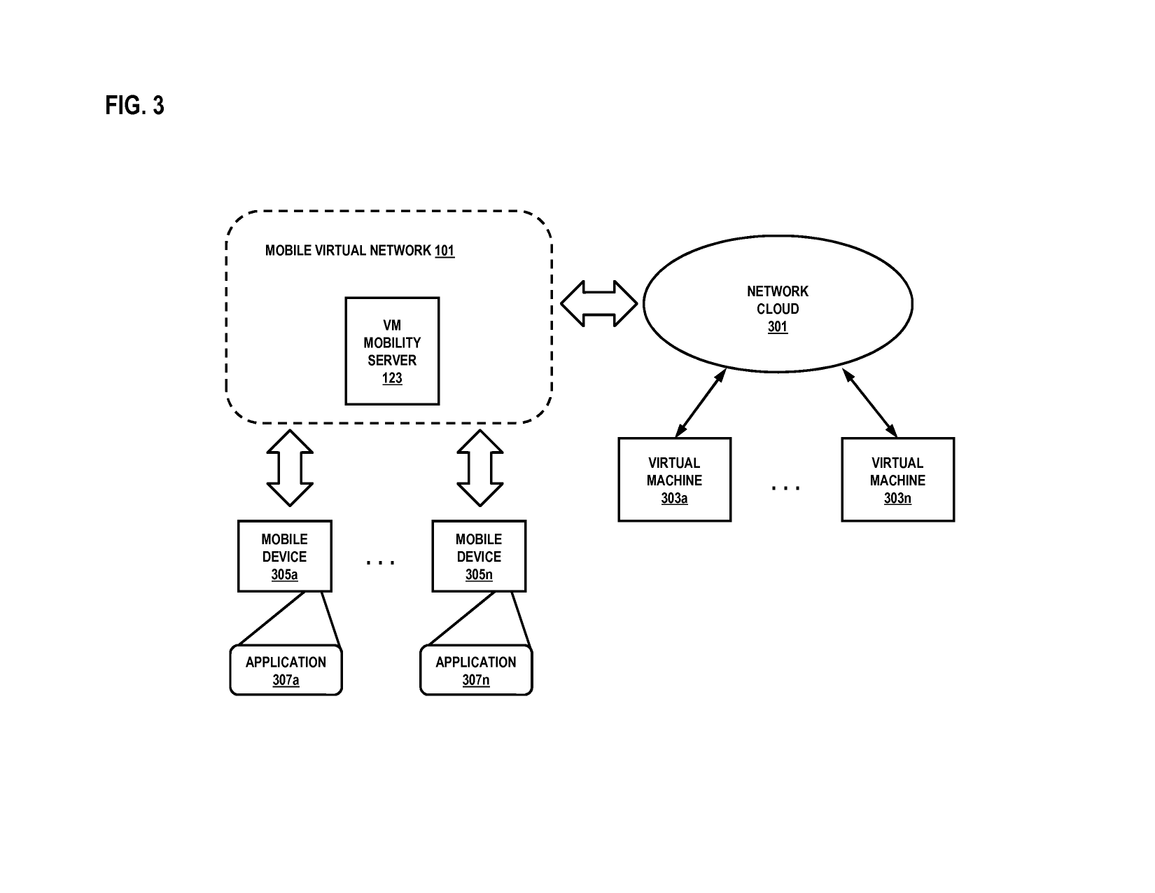

FIG. 3 is a diagram of a mobile virtual network 101 supporting services of a network cloud, according to one embodiment. Mobile virtual network 101, according to certain embodiments, can support cloud computing services and applications via network cloud 301. As mentioned, mobile virtual routers (MVR) can be dynamically self-configured to support cloud computing applications (“the cloud”). MVR can be set up and torn down dynamically via MVR signaling protocols. The described processes and arrangement allow the MVR to play a vital role in the cloud infrastructure to improve efficiency and performance by offering a flexible router provisioning mechanism in the network that best matches the cloud requirements. As noted, one major characteristic of the cloud is that both the application server (running on virtual machines or VMs) and application client (running on the user device) are mobile. In this architecture, the only static parts or components are the network resources and routers. By being static, the network resources may not be efficiently utilized to support the mobility of the cloud services, and in some cases, they may not even meet the cloud application requirements.

As shown, mobile virtual network 101 can employ VM mobility server 123 to manage virtual machines 303a-303n. In this example, mobile devices 305a-305n can execute respective applications 307a-307n to interact with the virtual machines 303a-303n. These applications 307a-307n, according to certain embodiments, may require constant mobility of virtual machines 303a-303n that are dedicated to their support. One example of such applications 307a-307n is a multi-party interactive application, e.g., game simulator with thousands/millions of users/players participating from many locations. The game or application can be continually executing (e.g., running 24-7), whereby users can be active or inactive based on their interest and time availability. Depending on the game dynamics and users' participation patterns, the network 101 may experience waves of active users, who are moving geographically according to time zones. This wave of active users is likely to require a continuous migration of VMs to efficiently run the game; possibly choosing VM locations that are in proximity of large pockets of active users for the best time response. With this continuous VMs migration, the mobile virtual network 101, which is established to support the application, may be constantly mutated to best match the moving entities, i.e., the pattern of active users and locations of VMs 303a-303n.

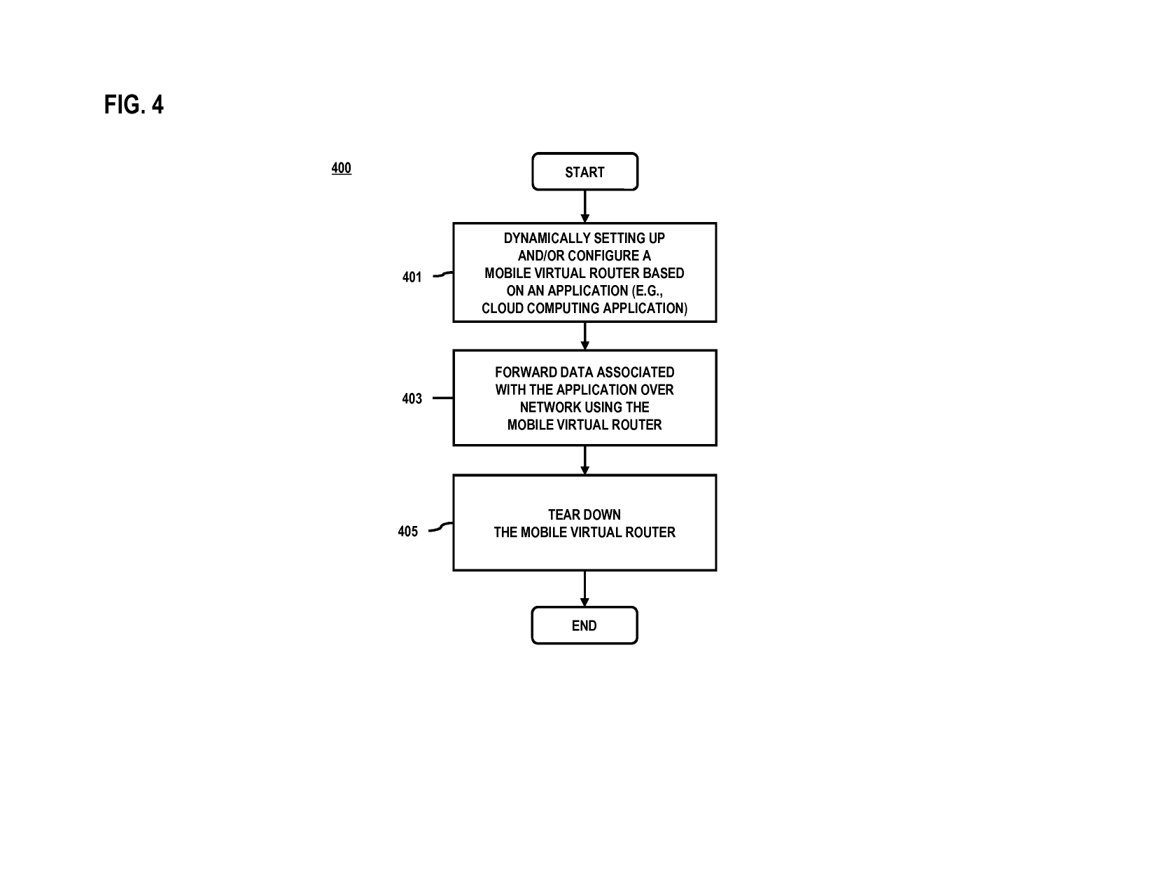

FIG. 4 is a flowchart of a process for dynamically configuring a mobile virtual router, according to one embodiment. For illustrative purpose, process 400 is described with respect to the system of FIG. 1. It is noted that the steps of process 400 may be performed in any suitable order, as well as combined or separated in any suitable manner. In step 401, process 400 involves dynamically setting up and/or configuring a mobile virtual router (e.g., router 103) based on an application. According to certain embodiments, the application is a cloud computing application. Process 400 then forwards data associated with the application over the network using the mobile virtual router, as in step 403. In one embodiment, the control plane instance, the forwarding plane instance, and the management plane instance are moveable among the physical routers. In step 405, the mobile virtual router is torn down.

It is contemplated that the resources of the physical routers of network 113 can be utilized simultaneously. Moreover, the control plane instance, the forwarding plane instance, and the management plane instance can be removed from one physical router and replicated on a different one of the physical routers. In this manner, the mobile virtual router can be relocated from one physical router to another physical router. According to one embodiment, a control signal can be generated to indicate the end of session of the relocation for transmission to a cloud module.

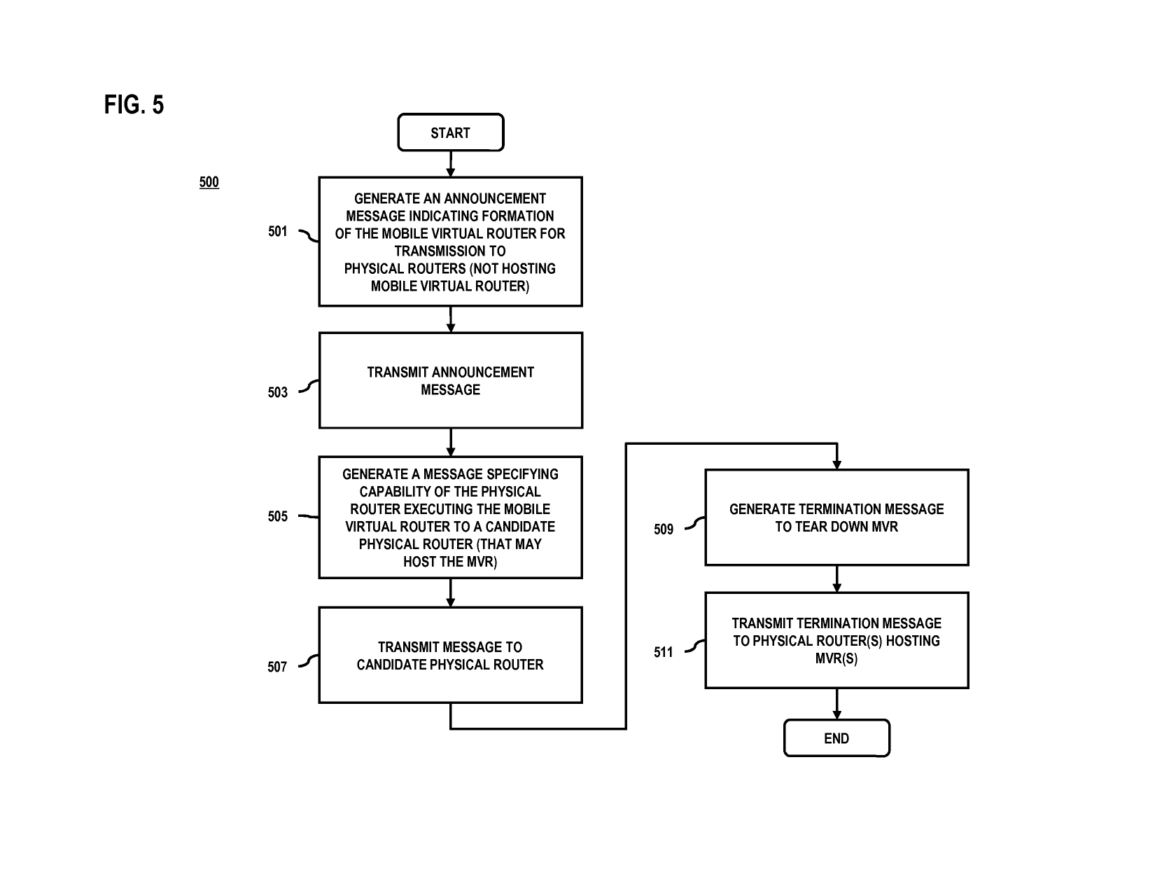

FIG. 5 is a flowchart of a process for notifying a candidate physical router to execute a mobile virtual router, according to one embodiment. It is noted that the steps of process 500 may be performed in any suitable order, as well as combined or separated in any suitable manner. In step 501, process 500 involves generating an announcement message indicating formation of the mobile virtual router (e.g., MVR 103 of FIG. 1). The announcement message is transmitted, per step 503, to a physical router that is not currently hosting the MVR. In one embodiment, process 500 also involves determining the capacity of a particular physical router. Accordingly, in step 505, an appropriate message is generated, whereby the message specifies capability of one of the physical routers 115-121 (executing the mobile virtual router; e.g., physical router 115) to another one of the physical routers 117-121. The other one of the physical router (e.g., router 117) is a candidate to host the mobile virtual router. Thus, in step 507, the message pertaining to the router capacity is forwarded to the candidate physical router 117.

After the MVR is established, at some point, the MVR can be torn down to free or reallocate resources. This tear down procedure, in certain embodiments, can be initiated by the generation of a termination message to tear down the MVR (step 509). Thereafter, the termination message is supplied to the appropriate physical router 117 that is hosting the MVR (step 511).

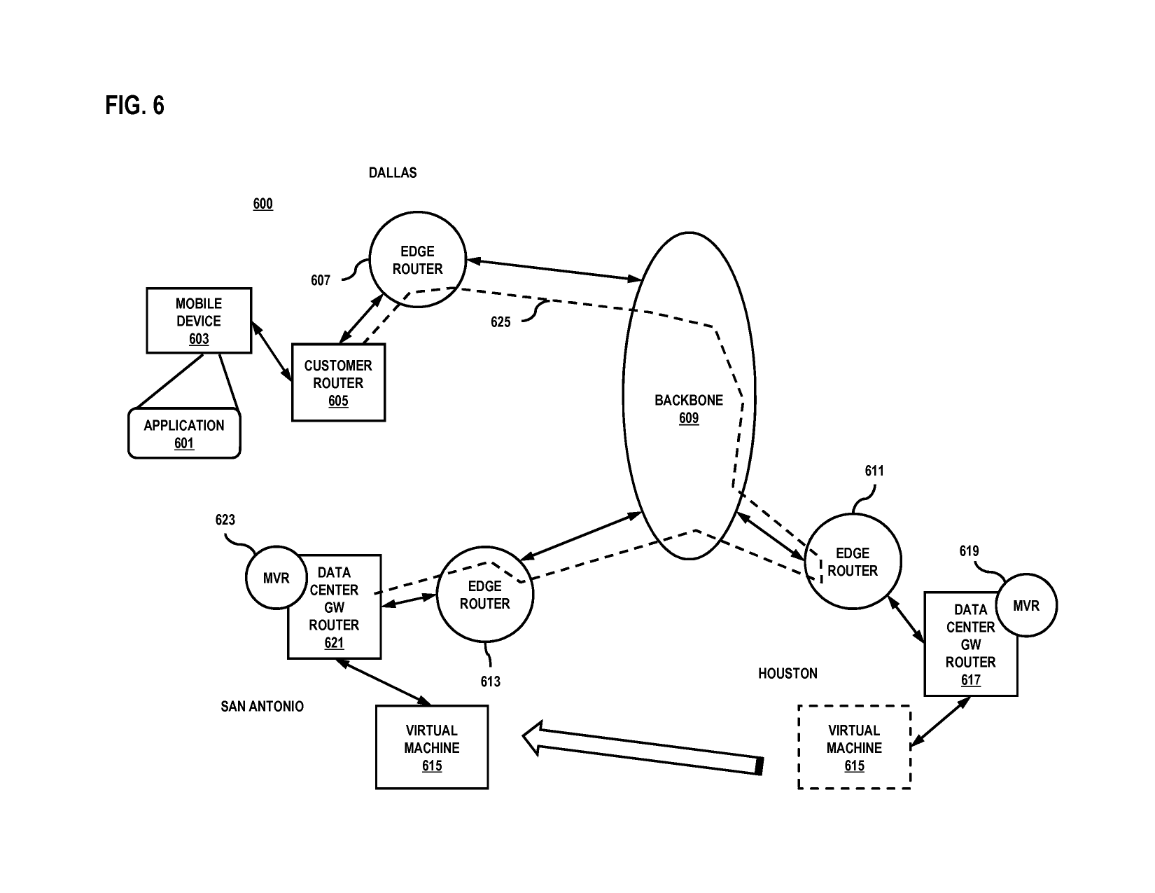

FIG. 6 is a diagram of an exemplary system with MVR deployment, according to one embodiment. By way of example, system 600 involves a user application 601 residing within a mobile device 603 at a first geographic location, e.g., the city of Dallas. At this location customer router 605 interfaces with a cloud service provider (CSP) edge router 607 that provides connectivity to a backbone or core network 609. In this example, the backbone network 609 serves two other locations, Houston and San Antonio, using edge routers 611 and 613, respectively. Edge router 611 at Houston provides connectivity to an application server (e.g., VM 615) via a data center gateway router 617. According to one embodiment, a MVR 619 is executed on router 617. Similarly, at the San Antonio site, edge router 613 interfaces with a data center gateway router 621, which houses a MVR 623. Under this scenario, the user application 601 is accessing application server (e.g., VM 615) residing in the data center server of the Houston site.

Due to some circumstances, the data center operator must move the VM 615 from the Houston data center to the San Antonio data center during service. In this case, the data flow from the user device to the VM will likely go through the following route 625: customer router 605 in Dallas to CSP edge router 607 in Dallas to CSP backbone 609 between Dallas and Houston to CSP edge router 611 in Houston to CSP data center gateway router 617 to CSP edge router 611 in Houston to CSP backbone 609 between Houston and San Antonio to CSP edge router 613 in San Antonio to CSP data center gateway router 621 in San Antonio.

This route 625, which exhibits a type of zig-zag routing problem induced by the VM mobility, can add significant end-to-end latency and un-necessary traffic load in the CSP backbone 609. To address this problem, one approach is to create MVRs 619 and 623 running on the data center gateway routers 617 and 621, respectively. When VM 615 is relocated, the MVR 619 in data center gateway router 617 associated with the VM 615 is also moved to the new physical data center gateway router 621. In that case, the routing tables of CSP edge routers 607, 611, and 613 are then updated based on the new customer edge (CE) router (MVR) reachability. The end-to-end application-server routes are thus re-optimized upon completion of the VMs relocation.

The processes described herein for enabling mobility in virtual routers—more specifically, mobile virtual routers can be configured/auto-configured to move from one physical router to another physical router without service and traffic interruption—may be implemented via software, hardware (e.g., general processor, Network Processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

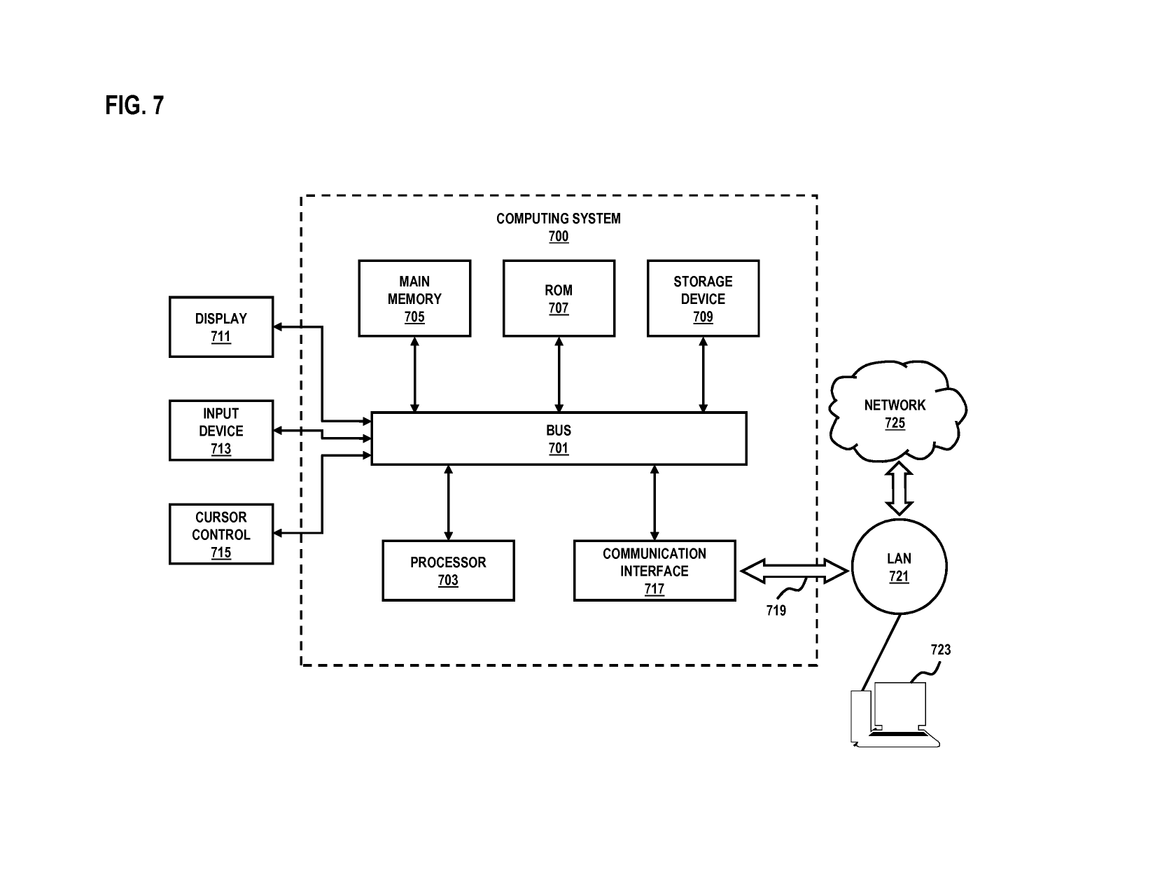

FIG. 7 illustrates computing hardware (e.g., computer system) 700 upon which exemplary embodiments can be implemented. The computer system 700 includes a bus 701 or other communication mechanism for communicating information and a processor 703 coupled to the bus 701 for processing information. The computer system 700 also includes main memory 705, such as a random access memory (RAM) or other dynamic storage device, coupled to the bus 701 for storing information and instructions to be executed by the processor 703. Main memory 705 can also be used for storing temporary variables or other intermediate information during execution of instructions by the processor 703. The computer system 700 may further include a read only memory (ROM) 707 or other static storage device coupled to the bus 701 for storing static information and instructions for the processor 703. A storage device 709, such as a magnetic disk or optical disk, is coupled to the bus 701 for persistently storing information and instructions.

The computer system 700 may be coupled via the bus 701 to a display 711, such as a cathode ray tube (CRT), liquid crystal display, active matrix display, or plasma display, for displaying information to a computer user. An input device 713, such as a keyboard including alphanumeric and other keys, is coupled to the bus 701 for communicating information and command selections to the processor 703. Another type of user input device is a cursor control 715, such as a mouse, a trackball, or cursor direction keys, for communicating direction information and command selections to the processor 703 and for controlling cursor movement on the display 711.

According to an exemplary embodiment, the processes described herein are performed by the computer system 700, in response to the processor 703 executing an arrangement of instructions contained in main memory 705. Such instructions can be read into main memory 705 from another computer-readable medium, such as the storage device 709. Execution of the arrangement of instructions contained in main memory 705 causes the processor 703 to perform the process steps described herein. One or more processors in a multi-processing arrangement may also be employed to execute the instructions contained in main memory 705. In alternative embodiments, hard-wired circuitry may be used in place of or in combination with software instructions to implement exemplary embodiments. Thus, exemplary embodiments are not limited to any specific combination of hardware circuitry and software.

The computer system 700 also includes a communication interface 717 coupled to bus 701. The communication interface 717 provides a two-way data communication coupling to a network link 719 connected to a local network 721. For example, the communication interface 717 may be a digital subscriber line (DSL) card or modem, an integrated services digital network (ISDN) card, a cable modem, a telephone modem, or any other communication interface to provide a data communication connection to a corresponding type of communication line. As another example, communication interface 717 may be a local area network (LAN) card (e.g. for Ethernet™ or an Asynchronous Transfer Model (ATM) network) to provide a data communication connection to a compatible LAN. Wireless links can also be implemented. In any such implementation, communication interface 717 sends and receives electrical, electromagnetic, or optical signals that carry digital data streams representing various types of information. Further, the communication interface 717 can include peripheral interface devices, such as a Universal Serial Bus (USB) interface, a PCMCIA (Personal Computer Memory Card International Association) interface, etc. Although a single communication interface 717 is depicted in FIG. 7, multiple communication interfaces can also be employed.

The network link 719 typically provides data communication through one or more networks to other data devices. For example, the network link 719 may provide a connection through local network 721 to a host computer 723, which has connectivity to a network 725 (e.g. a wide area network (WAN) or the global packet data communication network now commonly referred to as the “Internet”) or to data equipment operated by a service provider. The local network 721 and the network 725 both use electrical, electromagnetic, or optical signals to convey information and instructions. The signals through the various networks and the signals on the network link 719 and through the communication interface 717, which communicate digital data with the computer system 700, are exemplary forms of carrier waves bearing the information and instructions.

The computer system 700 can send messages and receive data, including program code, through the network(s), the network link 719, and the communication interface 717. In the Internet example, a server (not shown) might transmit requested code belonging to an application program for implementing an exemplary embodiment through the network 725, the local network 721 and the communication interface 717. The processor 703 may execute the transmitted code while being received and/or store the code in the storage device 709, or other non-volatile storage for later execution. In this manner, the computer system 700 may obtain application code in the form of a carrier wave.

The term “computer-readable medium” as used herein refers to any medium that participates in providing instructions to the processor 703 for execution. Such a medium may take many forms, including but not limited to computer-readable storage medium ((or non-transitory)—i.e., non-volatile media and volatile media), and transmission media. Non-volatile media include, for example, optical or magnetic disks, such as the storage device 709. Volatile media include dynamic memory, such as main memory 705. Transmission media include coaxial cables, copper wire and fiber optics, including the wires that comprise the bus 701. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the exemplary embodiments may initially be borne on a magnetic disk of a remote computer. In such a scenario, the remote computer loads the instructions into main memory and sends the instructions over a broadband connection or a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

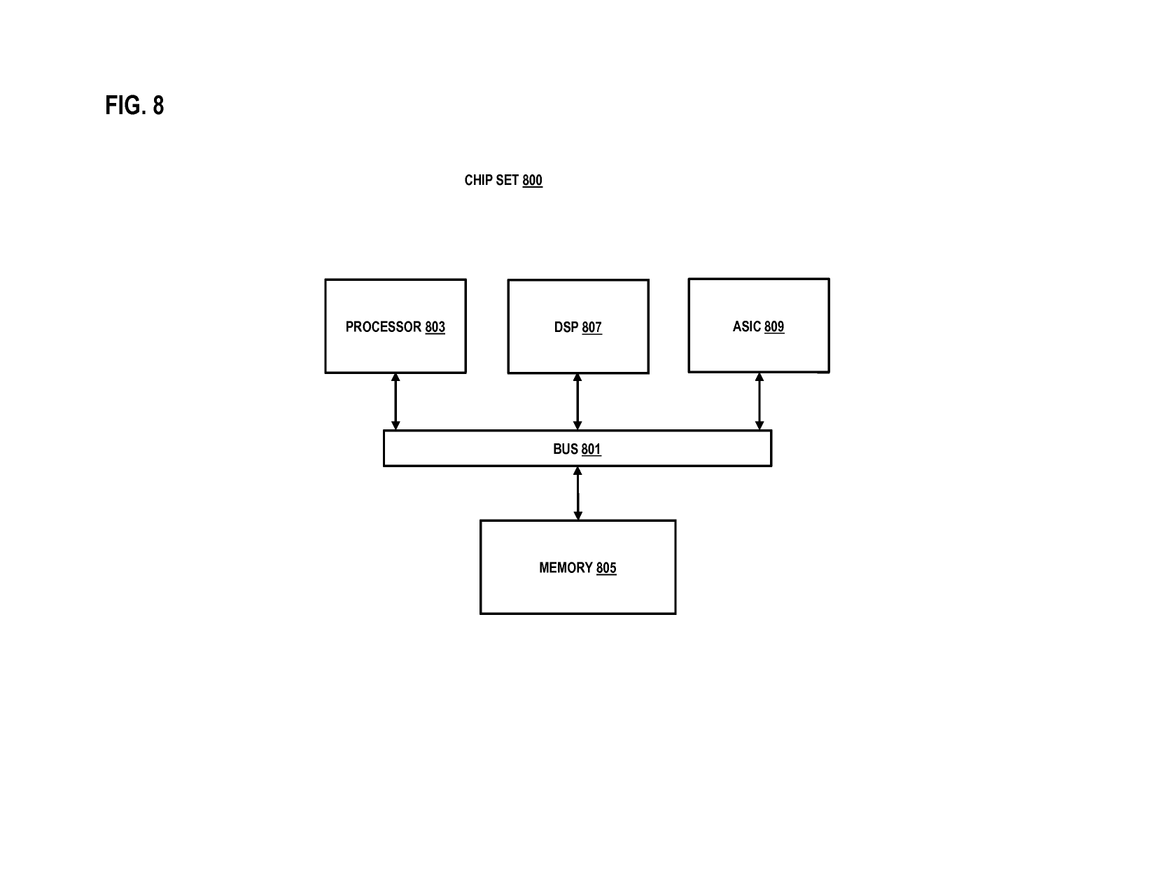

FIG. 8 illustrates a chip set 800 upon which an embodiment of the invention may be implemented. Chip set 800 is programmed to present a slideshow as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 800, or a portion thereof, constitutes a means for performing one or more steps of FIGS. 4 and 5.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to providing notification of a change in path condition. The memory 805 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
dynamically setting up and/or configuring a mobile virtual router based on an application, wherein the mobile virtual router includes a control plane instance, a forwarding plane instance, and a management plane instance; and
forwarding data associated with the application over the network using the mobile virtual router,
wherein the control plane instance, the forwarding plane instance, and the management plane instance are moveable among the plurality of physical routers.

2. A method according to claim 1, further comprising:
tearing down the mobile virtual router.

3. A method according to claim 1, wherein the mobile virtual router is configured to utilize resources of the plurality of physical routers.

4. A method according to claim 3, wherein the resources of the plurality of physical routers are utilized simultaneously.

5. A method according to claim 1, wherein the control plane instance, the forwarding plane instance, and the management plane instance are removed from one of the physical routers and replicated on a different one of the physical routers.

6. A method according to claim 1, further comprising:
generating a message specifying capability of one of the physical routers executing the mobile virtual router to another one of the physical routers, wherein the other one of the physical router is a candidate to host the mobile virtual router.

7. A method according to claim 1, further comprising:
generating an announcement message indicating formation or termination of the mobile virtual router.

8. A method according to claim 1, wherein the application is a cloud computing application.

9. A method according to claim 8, further comprising:
relocating the mobile virtual router from one of the physical routers to another one of the physical routers; and
generating a control signal to indicate of end of session of the relocation for transmission to a cloud module.

10. An apparatus comprising:
at least one processor; and
at least one memory including computer program code for one or more programs,
the at least one memory and the computer program code configured to, with the at least one processor, cause the apparatus to perform at least the following,
dynamically configure a mobile virtual router based on an application, wherein the mobile virtual router includes a control plane instance, a forwarding plane instance, and a management plane instance, and
forward data associated with the application over the network using the mobile virtual router,
wherein the control plane instance, the forwarding plane instance, and the management plane instance are moveable among the plurality of physical routers.

11. An apparatus according to claim 10, wherein the apparatus is further caused to:
tear down the mobile virtual router.

12. An apparatus according to claim 10, wherein the mobile virtual router is configured to utilize resources of the plurality of physical routers.

13. An apparatus according to claim 12, wherein the resources of the plurality of physical routers are utilized simultaneously.

14. An apparatus according to claim 10, wherein the control plane instance, the forwarding plane instance, and the management plane instance are removed from one of the physical routers and replicated on a different one of the physical routers.

15. An apparatus according to claim 10, wherein the apparatus is further caused to:
generate a message specifying capability of one of the physical routers executing the mobile virtual router to another one of the physical routers, wherein the other one of the physical router is a candidate to host the mobile virtual router.

16. An apparatus according to claim 10, wherein the apparatus is further caused to:
generate an announcement message indicating formation or termination of the mobile virtual router.

17. An apparatus according to claim 10, wherein the application is a cloud computing application.

18. An apparatus according to claim 17, wherein the apparatus is further caused to:
relocate the mobile virtual router from one of the physical routers to another one of the physical routers; and
generate a control signal to indicate of end of session of the relocation for transmission to a cloud module.

19. A system comprising:
a plurality of physical routers, one or more of the physical routers being configured to execute a mobile virtual router including a control plane instance, a forwarding plane instance, and a management plane instance,
wherein the control plane instance, the forwarding plane instance, and the management plane instance are moveable among the plurality of physical routers,
wherein the mobile virtual router is dynamically configured based on an application, and forwarding data associated with the application.

20. A system according to claim 19, wherein the control plane instance, the forwarding plane instance, and the management plane instance are removed from one of the physical routers and replicated on a different one of the physical routers.
